(19) United States
(12) Patent Application Publication
(10) Pub. No.: US 2025/0113231 A1
(43) Pub. Date: Apr. 3, 2025

(54) MEASUREMENT COLLECTION AND REPORTING

(71) Applicant: Nokia Technologies Oy, Espoo (FI)

(72) Inventors: Ethiraj ALWAR, Bangalore (IN); Anna PANTELIDOU, Massy (FR)

(21) Appl. No.: 18/825,711

(22) Filed: Sep. 5, 2024

(30) Foreign Application Priority Data
Sep. 29, 2023 (IN) 202341065559

(51) Int. Cl. H04W 24/10; H04W 36/32

(52) U.S. Cl. CPC H04W 24/10; H04W 36/32

(57) ABSTRACT

Embodiments of the present disclosure relate to apparatuses, methods, and computer readable storage media for data collection. A first apparatus prepares a measurement collection configuration comprising a list for Minimization of Drive Test (MDT) measurement collection and a measurement granularity. The list comprises at least one second apparatus and a corresponding cell. The first apparatus transmits, to the at least one second apparatus, the measurement collection configuration for triggering an MDT measurement activation for terminal device trajectory. The first apparatus receives, from the at least one second apparatus, at least one MDT measurement report for a machine learning (ML) model training at the first apparatus, the at least one measurement report comprising terminal device trajectory measurements collected based on the measurement collection configuration.

### CROSS-REFERENCE TO RELATED APPLICATION

This application claims priority from, and the benefit of, India Provisional Application No. 202341065559, filed Sep. 29, 2023, the contents of which are hereby incorporated by reference in their entirety.

### FIELDS

Various example embodiments of the present disclosure generally relate to the field of telecommunication and in particular, to methods, devices, apparatuses and computer readable storage medium for measurement collection and reporting.

### BACKGROUND

Artificial Intelligence (AI)/Machine Learning (ML)-based algorithms and models have been widely used for improving network performances in terms of energy saving, load balancing, mobility optimization, traffic steering, positioning and so on. When deploying AI/ML models, model training, monitoring, selection, update, inference and the like may be necessary for a fundamental life cycle management (LCM) process.

Network nodes (e.g., gNB) collect measurements from terminal devices (e.g., UE) in a network coverage, and the measurements can be used as training data for AI/ML model training and/or inference data for AI/ML model inference. In some scenarios, AI/ML model training is deployed at Operation Administration and Maintenance (OAM), while AI/ML model inference function resides within radio access network (RAN).

### SUMMARY

In a first aspect of the present disclosure, there is provided a first apparatus. The first apparatus comprises at least one processor; and at least one memory storing instructions that, when executed by the at least one processor, cause the first apparatus at least to: prepare a measurement collection configuration comprising a list for Minimization of Drive Test, MDT, measurement collection and a measurement granularity, the list comprising at least one second apparatus and a plurality of cells; transmit, to the at least one second apparatus, the measurement collection configuration for triggering an MDT measurement activation for terminal device trajectory; and receive, from the at least one second apparatus, at least one MDT measurement report comprising terminal device trajectory measurements collected based on the measurement collection configuration.

In a second aspect of the present disclosure, there is provided a second apparatus. The second apparatus comprises at least one processor; and at least one memory storing instructions that, when executed by the at least one processor, cause the second apparatus at least to: receive, from a first apparatus, a measurement collection configuration comprising a list for MDT measurement collection and a measurement granularity, the list comprising at least the second apparatus and a plurality of cells; collect, based on the measurement collection configuration, terminal device trajectory measurements from at least one terminal device in at least a part of the plurality of cells; and transmit, to the first apparatus, an MDT measurement report comprising the terminal device trajectory measurements.

In a third aspect of the present disclosure, there is provided a method. The method comprises: preparing, at a first apparatus, a measurement collection configuration comprising a list for MDT measurement collection and a measurement granularity, the list comprising at least one second apparatus and a plurality of cells; transmitting, to the at least one second apparatus, the measurement collection configuration for triggering a MDT measurement activation for terminal device trajectory; and receiving, from the at least one second apparatus, at least one MDT measurement report comprising terminal device trajectory measurements collected based on the measurement collection configuration.

In a fourth aspect of the present disclosure, there is provided a method. The method comprises: receiving, at a second apparatus and from a first apparatus, a measurement collection configuration comprising a list for MDT measurement collection and a measurement granularity, the list comprising at least the second apparatus and a plurality of cells; collecting, based on the measurement collection configuration, terminal device trajectory measurements from at least one terminal device in at least a part of the plurality of cells; and transmitting, to the first apparatus, an MDT measurement report comprising the terminal device trajectory measurements.

In a fifth aspect of the present disclosure, there is provided a first apparatus. The first apparatus comprises: means for preparing a measurement collection configuration comprising a list for MDT measurement collection and a measurement granularity, the list comprising at least one second apparatus and a plurality of cells; means for transmitting, to the at least one second apparatus, the measurement collection configuration for triggering an MDT measurement activation for terminal device trajectory; and means for receiving, from the at least one second apparatus, at least one MDT measurement report comprising terminal device trajectory measurements collected based on the measurement collection configuration.

In a sixth aspect of the present disclosure, there is provided a second apparatus. The second apparatus comprises: means for receiving, from a first apparatus, a measurement collection configuration comprising a list for MDT measurement collection and a measurement granularity, the list comprising at least the second apparatus and a plurality of cells; means for collecting, based on the measurement collection configuration, terminal device trajectory measurements from at least one terminal device in at least a part of the plurality of cells; and means for transmitting, to the first apparatus, an MDT measurement report comprising the terminal device trajectory measurements.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a schematic diagram of a functional framework for RAN intelligence;

FIG. 3 illustrates an example procedure for AI/ML model training in OAM and AI/ML model inference in RAN node;

FIG. 4 illustrates an example mechanism for measurement configuration and reporting between RAN node and OAM according to some example embodiments of the present disclosure;

FIG. 5 illustrates a signaling chart for a measurement configuration and reporting process according to some example embodiments of the present disclosure;

FIG. 6A illustrates a schematic diagram of beam level measurements exposed from gNB-DU to OAM according to some example embodiments of the present disclosure;

FIG. 6B illustrates a schematic diagram of cell level measurements exposed from gNB-CU to OAM according to some example embodiments of the present disclosure;

FIG. 6C illustrates a schematic diagram of beam level and cell level measurements exposed from gNB-CU to OAM according to some example embodiments of the present disclosure;

FIG. 7 illustrates a signaling chart for a measurement configuration and reporting process of cell level measurements and beam level measurements according to some example embodiments of the present disclosure;

FIG. 8 illustrates a schematic diagram of distribution of terminal device trajectory in cell according to some example embodiments of the present disclosure;

FIG. 9 illustrates a flowchart of a method implemented at an apparatus according to some example embodiments of the present disclosure;

FIG. 10 illustrates a flowchart of a method implemented at an apparatus according to some example embodiments of the present disclosure;

FIG. 11 illustrates a simplified block diagram of a device that is suitable for implementing example embodiments of the present disclosure; and

FIG. 12 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, a machine learning (ML) entity may be an ML model or may contain an ML model and ML model related metadata. The ML entity may be managed as a single composite entity. In some example embodiments, the ML entity may be implemented as a MLApp.

To facilitate understanding of the terminologies, RANI agreements on the list of terminologies used for AI/ML are provided below:

AI/ML Model: A data driven algorithm that applies AI/ML techniques to generate a set of outputs based on a set of inputs.

AI/ML model delivery: A generic term referring to delivery of an AI/ML model from one entity to another entity in any manner. Note: An entity could mean a network node/function (e.g., gNB, LMF, etc.), UE, proprietary server, etc.

AI/ML model Inference: A process of using a trained AI/ML model to produce a set of outputs based on a set of inputs.

AI/ML model testing: A subprocess of training, to evaluate the performance of a final AI/ML model using a dataset different from one used for model training and validation. Differently from AI/ML model validation, testing does not assume subsequent tuning of the model.

AI/ML model training: A process to train an AI/ML Model [by learning the input/output relationship] in a data driven manner and obtain the trained AI/ML Model for inference.

AI/ML model transfer: Delivery of an AI/ML model over the air interface in a manner that is not transparent to 3GPP signalling, either parameters of a model structure known at the receiving end or a new model with parameters. Delivery may contain a full model or a partial model.

AI/ML model validation: A subprocess of training, to evaluate the quality of an AI/ML model using a dataset different from one used for model training, that helps selecting model parameters that generalize beyond the dataset used for model training.

Data collection: A process of collecting data by the network nodes, management entity, or UE for the purpose of AI/ML model training, data analytics and inference.

Federated learning/federated training: A machine learning technique that trains an AI/ML model across multiple decentralized edge nodes (e.g., UEs, gNBs) each performing local model training using local data samples. The technique requires multiple interactions of the model, but no exchange of local data samples.

Functionality identification: A process/method of identifying an AI/ML functionality for the common understanding between the NW and the UE. Note: Information regarding the AI/ML functionality may be shared during functionality identification. Where AI/ML functionality resides depends on the specific use cases and sub use cases.

Model activation: enable an AI/ML model for a specific function.

Model deactivation: disable an AI/ML model for a specific function.

Model download: Model transfer from the network to UE.

Model identification: A process/method of identifying an AI/ML model for the common understanding between the NW and the UE. Note: The process/method of model identification may or may not be applicable. Note: Information regarding the AI/ML model may be shared during model identification.

Model monitoring: A procedure that monitors the inference performance of the AI/ML model.

Model parameter update: Process of updating the model parameters of a model.

Model selection: The process of selecting an AI/ML model for activation among multiple models for the same AI/ML enabled feature. Note: Model selection may or may not be carried out simultaneously with model activation.

Model switching: Deactivating a currently active AI/ML model and activating a different AI/ML model for a specific function.

Model update: Process of updating the model parameters and/or model structure of a model.

Model upload: Model transfer from UE to the network.

Network-side (AI/ML) model: An AI/ML Model whose inference is performed entirely at the network.

Offline field data: The data collected from field and used for offline training of the AI/ML model.

Offline training: An AI/ML training process where the model is trained based on collected dataset, and where the trained model is later used or delivered for inference. Note: This definition only serves as a guidance. There may be cases that may not exactly conform to this definition but could still be categorized as offline training by commonly accepted conventions.

Online field data: The data collected from field and used for online training of the AI/ML model.

Online training: An AI/ML training process where the model being used for inference) is (typically continuously) trained in (near) real-time with the arrival of new training samples. Note: the notion of (near) real-time vs. non real-time is context-dependent and is relative to the inference time-scale. Note: This definition only serves as a guidance. There may be cases that may not exactly conform to this definition but could still be categorized as online training by commonly accepted conventions. Note: Fine-tuning/re-training may be done via online or offline training. (This note could be removed when we define the term fine-tuning.)

Reinforcement Learning (RL): A process of training an AI/ML model from input (a.k.a. state) and a feedback signal (a.k.a. reward) resulting from the model's output (a.k.a. action) in an environment the model is interacting with.

Semi-supervised learning: A process of training a model with a mix of labelled data and unlabelled data.

Supervised learning: A process of training a model from input and its corresponding labels.

Two-sided (AI/ML) model: A paired AI/ML Model(s) over which joint inference is performed, where joint inference comprises AI/ML Inference whose inference is performed jointly across the UE and the network, i.e, the first part of inference is firstly performed by UE and then the remaining part is performed by gNB, or vice versa.

UE-side (AI/ML) model: An AI/ML Model whose inference is performed entirely at the UE.

Unsupervised learning: A process of training a model without labelled data.

Proprietary-format models: ML models of vendor-/device-specific proprietary format, from 3GPP perspective. They are not mutually recognizable across vendors and hide model design information from other vendors when shared. Note: An example is a device-specific binary executable format.

Open-format models: ML models of specified format that are mutually recognizable across vendors and allow interoperability, from 3GPP perspective. They are mutually recognizable between vendors and do not hide model design information from other vendors when shared.

As used herein, the term “network function (NF)” may refer to individual components or services for control plane (C-Plane) or user plane (U-plane) in the core network (CN). Each of the network functions may be considered as a logical network element that is independent and autonomous. As a result, addition, updating, expanding and/or removal of a network function would not affect other network functions in CN. The network functions may communicate with each other via respective air interfaces.

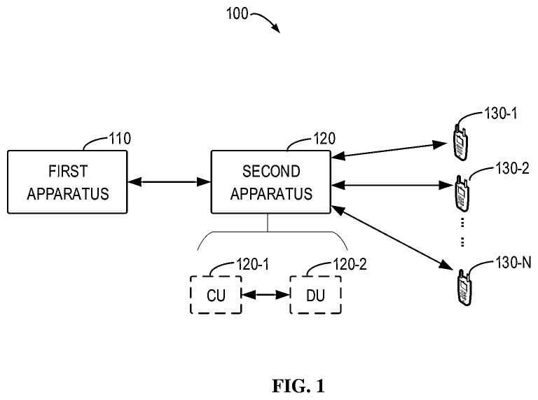

FIG. 1 illustrates an example communication environment 100 in which example embodiments of the present disclosure can be implemented. The communication environment 100 may be a network framework supporting AI/ML models and features supporting various use cases, such as, UE mobility/trajectory prediction, network energy saving, load balancing, mobility optimization, traffic steering and so on. The AI/ML models may be data driven algorithms applying AI/ML techniques to generate a set of outputs based on a set of inputs. Such AI/ML models may be deployed at any one or a combination of UE, gNB, OAM, and over-the-top (OTT) server.

In the following, some of the example embodiments will be described in context of collection and reporting of data related to UE mobility or trajectory, however, other measurements are also applicable to implementations of the solution provided in the example embodiments of the present disclosure. Thus, the present disclosure is not limited in this regard.

The communication environment 100 may comprise a first apparatus 110, a second apparatus 120 and a plurality of terminal devices 130-1 to 130-N, which may communicate with each other.

The first apparatus 110 may be a network device for implementing OAM. The second apparatus 120 may be a network device in RAN. The second apparatus 120 may provide a radio coverage for terminal devices, for example, the third apparatuses 130-1 to 130-N (which may be collectively referred to as the third apparatus 130 hereinafter).

In some example embodiments, the second apparatus 120 may be a single network device, such as, gNB. Alternatively, in some example embodiments, the second apparatus 120 may be implemented as discrete components, either logically or physically. In the example shown in FIG. 1, the first apparatus 120 may further comprise a centralized unit (CU) 120-1 and a distributed unit (DU) 120-2. The CU 120-1 may be divided into CU-CP and CU-UP. In particular, CU-CP may be connected to DU 120-2 via F1-C interface, while CU-UP may be connected to DU 120-2 via F1-U interface.

It should be understood that a single DU is shown for illustrative purpose, and in some other embodiments, the second apparatus 120 may comprise more than one DU. Thus, the present disclosure is not limited in this regard.

AI/ML models may be deployed in the communication environment 100. In some example embodiments, the AI/ML model training may be performed at the first apparatus 110, while the AI/ML model inference function may reside within the second apparatus 120. To this end, the second apparatus 120 may collect data from the third apparatus 130 for LCM purposes, e.g., model training, monitoring, selection, update, inference, etc. The data to be collected may be UE measurements, performance measurements, radio resource management (RRM) measurements, etc. The communication network 100 may utilize many frameworks for data collection, such as, self-organized network (SON), Minimization of Drive Test (MDT), and so on.

In some example embodiments, a link from the second apparatus 120 to the third apparatus 130 is referred to as a downlink (DL), and a link from the third apparatus 130 to the second apparatus 120 is referred to as an uplink (UL). In DL, the second apparatus 120 is a transmitting (TX) device (or a transmitter) and the third apparatus 130 is a receiving (RX) device (or a receiver). In UL, the third apparatus 130 is a TX device (or a transmitter) and the second apparatus 120 is a RX device (or a receiver).

In some example embodiments, operations described in connection with a terminal device may be implemented at a network device or other device, and operations described in connection with a network device may be implemented at a terminal device or other device.

It is to be understood that the number of apparatuses and their connections shown in FIG. 1 are only for the purpose of illustration without suggesting any limitation. The communication network 100 may include any suitable number of apparatuses configured to implementing example embodiments of the present disclosure. Although not shown, it would be appreciated that one or more additional apparatuses and connections may be deployed in the communication network 100.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

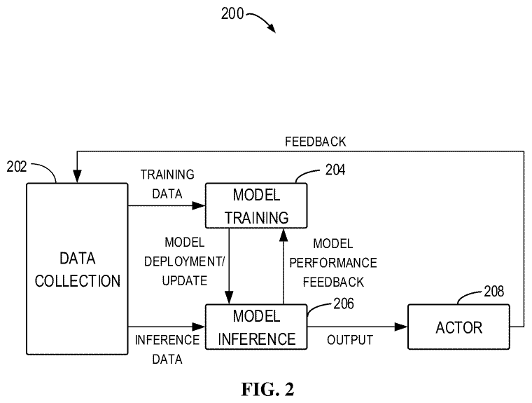

FIG. 2 illustrates a schematic diagram of a functional framework 200 for RAN intelligence. As shown in FIG. 2, the data collection function 202 may provide training data and inference data as input data to the model training function 204 and the model inference function 206 respectively. Examples of input data may include measurements from UEs or other network entities, feedback from the actor 208, and output from an AI/ML model.

In the functional framework 200, the model training function 204 performs the AI/ML model training, validation, and testing which may generate model performance metrics as part of the model testing procedure. The model training function 204 may be also responsible for data preparation (e.g., data pre-processing and cleaning, formatting, and transformation) based on the training data delivered by the data collection function 202, if required.

The model training function 204 may perform model deployment or update for the model inference function 206. In particular, model deployment or update may be used to initially deploy a trained, validated, and tested AI/ML model to the model inference function 206 or to deliver an updated model to the model inference function 206.

The model inference function 206 may provide AI/ML model inference output (e.g., predictions or decisions). Moreover, the model inference function 206 may provide model performance feedback to the model training function 204 when applicable. The model performance feedback may be used for monitoring the performance of the AI/ML model. The model inference function 206 may be also responsible for data preparation (e.g., data pre-processing and cleaning, formatting, and transformation) based on inference data delivered by the data collection function 202, if required.

The actor 208 may be a function that receives the output from the model inference function 206 and triggers or performs corresponding actions. The actor 208 may trigger actions directed to other entities or to itself. The actor 208 may also provide feedback to the data collection function 202. The feedback refers to information that may be needed to derive training data, inference data or to monitor the performance of the AI/ML Model and its impact to the network through updating of KPIs and performance counters.

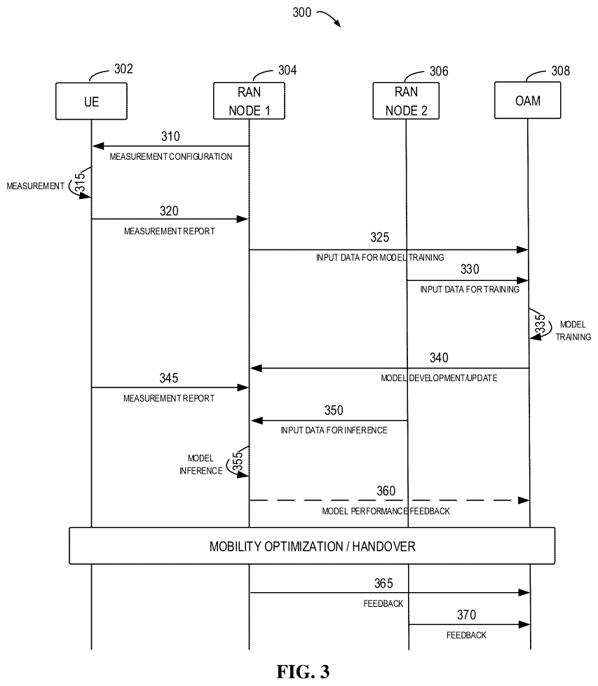

FIG. 3 illustrates an example procedure 300 for AI/ML model training in OAM and AI/ML model inference in RAN node. Assuming that an AI/ML model is deployed at the RAN node 2 (indicated by “306”), the AI/ML model may generate required input, such as, resource status and utilization prediction or estimation, etc.

In the procedure 300, the RAN node 1 (indicated by “304”) transmits (310) a configuration message comprising measurement information to UE 302. As a result, the UE 302 collects (315) measurements based on the measurement information. For example, the measurements may relate to Reference Signal Receiving Power (RSRP), Reference Signal Receiving quality (RSRQ), Signal to Interference plus Noise Ratio (SINR) of the serving cell and neighboring cells.

The UE 302 transmits (320) a measurement report message comprising the collected measurements to the RAN node 1. Upon receipt of the measurement report message, the NG-RAN node 1 then transmits (325) the input data for AI/ML model training to OAM 308. The input data for AI/ML model training may comprise the required input information from the NG-RAN node 1 and the measurements from UE 302.

The RAN node 2 may also transmit (330) the input data for AI/ML model training to OAM 308. The input data for AI/ML model training may comprise the required input information from the NG-RAN node 2. If the NG-RAN node 2 executes the AI/ML model, the input data for I/ML model training may comprise a corresponding inference result from the NG-RAN node 2.

Accordingly, the OAM 308 performs (335) AI/ML model training for UE mobility optimization by leveraging the measurements. The OAM 308 then transmits (340) an AI/ML model deployment message to deploy the trained or updated AI/ML model into the NG-RAN node 1 and/or NG-RAN node 2. Additionally, the NG-RAN node may continue the AI/ML model training based on the AI/ML model received from OAM 308.

The NG-RAN node 1 receives (345) a measurement report as inference data for UE mobility optimization from the UE 302. Additionally, the NG-RAN node 1 may receive (350) the input data for AI/ML model inference from the NG-RAN node 2 for UE mobility optimization. In particular, the input data for AI/ML model inference may comprise the required input information from the NG-RAN node 2. If the NG-RAN node 2 executes the AI/ML model, the input data for AI/ML model inference may include a corresponding inference result from the NG-RAN node 2.

Accordingly, the NG-RAN node 1 performs (355) AI/ML model inference by leveraging the measurements, and outputs a prediction, for example, UE trajectory prediction, target cell prediction, target NG-RAN node prediction, etc. Additionally, the NG-RAN 1 may transmit (360) model performance feedback to the OAM 308 if applicable.

According to the prediction, recommended actions or configuration, the NG-RAN node 1, a target RAN node that is represented by the RAN node 2 in the procedure 300, and the UE 302 perform the mobility optimization or handover procedure to hand over the UE 302 from the NG-RAN node 1 to the target NG-RAN node.

The NG-RAN node 1 and the NG-RAN node 2 then transmit (365, 370) feedback information to the OAM 308, respectively.

In the exiting communication system, network-controlled mobility applies to UEs in RRC_CONNECTED mode, and is categorized into two types of mobility, that is, cell level mobility and beam level mobility. Beam level mobility may comprise intra-cell beam level mobility and inter-cell beam level mobility.

Cell level mobility may require explicit RRC signaling to be triggered, i.e., a handover procedure. Beam-level mobility may be within a cell, or between cells, and the latter case is referred to as inter-cell beam management (ICBM). For ICBM, a UE receives or transmits UE dedicated channels/signals via a TRP associated with a PCI different from the Physical Cell Identifier (PCI) of a serving cell, while non-UE-dedicated channels/signals can only be received via a Transmission and Reception Point (TRP) associated with the PCI of the serving cell. The gNB provides to the UE via RRC signaling a measurement configuration comprising configurations of Synchronization Signal Block (SSB)/Channel State Information (CSI) resources and resource sets, reports and trigger states for triggering channel and interference measurements and reports. In case of ICBM, a measurement configuration comprises SSB resources associated with PCIs different from the PCI of the serving cell. Beam Level Mobility is then dealt with at lower layers by means of physical layer and MAC layer control signaling, and RRC is not required to know which beam is being used at a given point in time.

UE Trajectory indicates trajectory information of UE(s) in radio coverage i.e., the cells and beams visited by a UE (across the different RRC States) and the corresponding time of stay. This is a key input data for the UE Trajectory Prediction ML Model. When the AIML Model Training is performed at OAM, this input data needs to be available at OAM. It is expected to use UE measurements related to UE trajectory for AI/ML-based network performance optimization in the existing network framework including MDT and RRM measurements. As previously mentioned, AI/ML model training is deployed at OAM. However, there is no mechanism for collecting and reporting UE trajectory measurements from RAN towards OAM. As a result, model training at OAM may not be possible for all the use cases, even though RAN nodes can collect such information.

According to the example embodiments of the present disclosure, there is provided a solution that enables a NG-RAN node to provide UE Trajectory Information to OAM. The RAN node monitors and collects UE Trajectory Information based on certain events or conditions, and provides it to the OAM. As a result, the UE measurements related to UE Trajectory can be used as input data samples for offline training of UE Trajectory Prediction AI/ML models in the OAM or analyzing the performance by using the PM counters or KPIs.

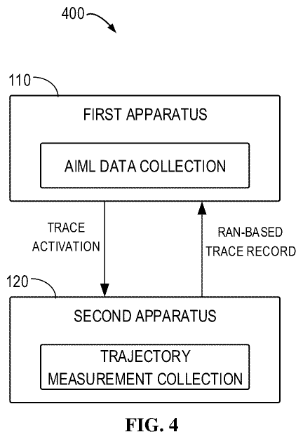

The proposed solution will be discussed in detail in connection with FIGS. 4 to 9. FIG. 4 illustrates an example mechanism 400 for measurement configuration and reporting between RAN node and OAM according to some example embodiments of the present disclosure. For example, the OAM and the RAN node may be the first apparatus 110 and the second apparatus 120 as shown in FIG. 1. For the purpose of discussion, reference is made to FIG. 1 to describe the mechanism 400.

In the example mechanism 400, the first apparatus 110 may activate a new trace for UE measurements (e.g., UE trajectory data). The MDT measurement activation may comprise a configuration for collecting UE trajectory data at a certain level (e.g., a cell level or a beam level) based on a corresponding conditions or events being met at corresponding UEs taking those measurements. The second apparatus 120 may collect the UE measurements based on the received configuration from the first apparatus and may report an NG-RAN-based trace record (e.g., trace session records) to the first apparatus 110. Such UE trajectory data may then be subsequently used as input data samples for AI/ML model training purpose.

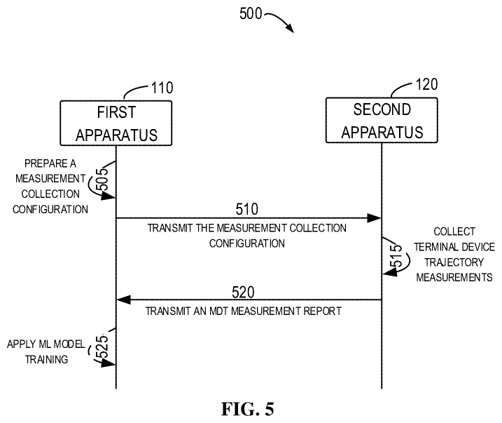

The signaling and interaction associated with example mechanism 400 will be described in connection with FIG. 5, which illustrates a signaling chart for a measurement configuration and reporting process 500 according to some example embodiments of the present disclosure. The measurement configuration and reporting process 500 involves the first apparatus 110 and the second apparatus 120. For the purpose of discussion, reference is made to FIG. 1 to describe the process 500.

In the process 500, the first apparatus 110 prepares (505) a measurement collection configuration comprising a list for MDT measurement collection and a measurement granularity. The list may comprise at least one network device in RAN associated with the MDT measurement collection and a plurality of cells including the serving cell. In the example shown in FIG. 1, the at least one network device in RAN is the second apparatus 120, and in particular, it may be the CU 120-1 and/or the DU 120-2. In some example embodiments, the plurality of cells may comprise a set of cells for the MDT measurement collection.

In some example embodiments, the measurement collection configuration may be associated with a certain UE measurement to be collected in the RAN, for example, UE trajectory data. UE trajectory data may be also referred to as terminal device trajectory measurements, which indicates trajectory information of a UE in the radio coverage i.e., the cells and beams visited by a UE (which may be across different RRC States) and the corresponding time of stay. Thus, this is considered to be a key input data for the UE trajectory prediction ML Model. In case that the AI/ML model training is performed at OAM, UE trajectory data needs to be available for input data at OAM.

It should be noted that some of the embodiments are described in a context of mobility/trajectory prediction or optimization, however, this is given as one of various use cases suitable for implementing the solutions provided by the present disclosure without any limitation. In practice, the proposed solutions are also applicable to any other AI/ML models, functions, or use cases. Thus, the present disclosure is not limited to this regard.

In some example embodiments, the terminal device trajectory measurements may be collected by the MDT framework, and thus in this case, the terminal device trajectory measurements may be also referred to as NG-RAN-based MDT measurements. The terminal device trajectory measurements may also be Performance Measurement (PM) counter measurements, or Key Performance Indication (KPI) measurements related to UE trajectory.

Table 1 shows a list of RAN-based MDT measurements can measure and report to the first apparatus 110.

TABLE 1
Examples of RAN-based MDT measurements

| Measurement | | Measurement |
|---|---|---|
| ID | Description | Configured by |
| M4 | Data volume measurement separately | gNB-CU-CP |
| | for DL and UL per DRB per UE | |
| M5 | Average UE throughput measurement | gNB-DU |
| | separately for DL and UL, per DRB | |
| | per UE and per UE for the DL, per | |
| | DRB per UE and per UE for the UL, | |
| | by gNB | |
| M6 | Packet Delay measurement separately | gNB-CU-UP and |
| | for DL and UL, per DRB per UE | gNB-DU |
| M7 | Packet loss rate measurement | gNB-CU-UP and |
| | separately for DL and UL, per DRB | gNB-DU |
| | per UE | |

The measurement granularity may be associated with a granularity of UE trajectory ML model, and comprise a cell level, beam level, or a combination of both of them.

TABLE 2
shows the granularity of UE trajectory ML model

| RAN-based | | | |
|---|---|---|---|
| measurement | | Measured | Measurement |
| ID | Description | at | reported by |
| Rx | Cell Level UE Trajectory | gNB-CU-CP | gNB-CU-CP |
| | containing the Visited | | |
| | Cells and Time of stay in | | |
| | each cell | | |
| Ry | Beam level UE | gNB-DU | gNB-DU |
| | Trajectory containing the | | gNB-CU-CP |
| | visited beams and time of | | |
| | stay in each beam | | |
| Rz | Cell Level and Beam | gNB-CU-CP | gNB-CU-CP |
| | Level UE Trajectory | gNB-DU | |

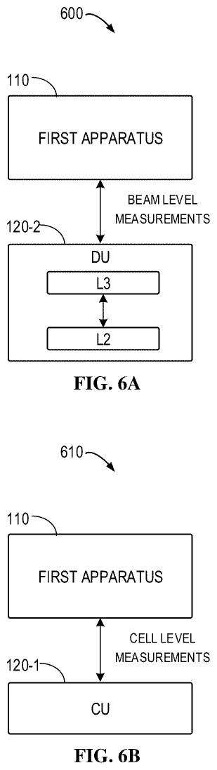

In case of UE mobility at cell level, which is controlled by a gNB-CU-CP (e.g., the CU 120-1), the measurement collection configuration may be a configuration of layer 3 measurements. In case of UE mobility at beam level, which is controlled by a gNB-DU (e.g., the DU 120-1), the measurement collection configuration may be a beam measurement configuration. In case of UE mobility at both cell level and beam level, both of the gNB-CU-CP and gNB-DU are involved. These cases will be discussed in detail later in connection with FIGS. 6A to 6C.

The first apparatus 110 transmits (510) the measurement collection configuration to the second apparatus 120. Depending on the configured measurement granularity, the measurement collection configuration may be transmitted to only the CU 120-1, only the DU 120-2, or both of them.

The measurement collection configuration may trigger an MDT measurement activation for terminal device trajectory. Accordingly, the second apparatus 120 collects (515) terminal device trajectory measurements from at least one terminal device in at least a part of the plurality of cells based on the measurement collection configuration.

The second apparatus 120 then transmits (520) an MDT measurement report comprising the terminal device trajectory measurements to the first apparatus 110.

In some example embodiments, the first apparatus 110 may then apply (525) ML model training on at least one ML model by using the terminal device trajectory measurements.

Alternatively, or additionally, in some example embodiments, the first apparatus 110 may perform at least one of the following based on the terminal device trajectory measurements: trouble shooting, performance analysis at a cell level or at a node level, or ML training or retraining by using the terminal device trajectory measurements as input data samples.

In some example embodiments, the first apparatus 110 may expect to collect beam level UE trajectory information only, and thus the configured measurement granularity corresponds to a beam level measurement collection. In this case, the measurement configuration and reporting may involve the first apparatus 110 and the DU 120-2. In other words, beam level measurements are exposed from the DU 120-2 to the first apparatus 110.

FIG. 6A illustrates a schematic diagram of beam level measurements exposed from gNB-DU to OAM according to some example embodiments of the present disclosure. In the scenario 600, the first apparatus 110 may directly configure the DU 120-2 with a beam level measurement collection configuration. Alternatively, the first apparatus 110 may configure the DU 120-2 through the CU 120-1. In this case, the measurement report may also be provided to the first apparatus 110 through the CU 120-1.

The beam level measurement collection configuration may trigger beam mobility event monitoring at the DU 120-2. The DU 120-2 may select at least one terminal device for measurement collection. The DU 120-2 may start collecting the beam level measurements on L2, for example, the visited beams and the time of stay for a terminal device in each of the beams, when the selected terminal device is redirected from one beam to another beam. The collected measurements may be transmitted from L2 to L3, and then exposed to the first apparatus 110.

Table 3 shows an example of beam level measurement collection in terms of time of stay of UE in beams of given cells, which considers two cells C1 and C2, and each cell has two beams B1 and B2. It should be understood that the example in table 3 is given for illustrative purpose, and other measurements and forms are also suitable for implementation of the example embodiments.

TABLE 3
Beam level measurement collection

| | B1 | B2 |
|---|---|---|
| C1 Beam ID | | |
| Time of stay | X1 mins | X2 mins |
| C2 Beam ID | | |
| Time of stay | Y1 mins | Y2 mins |

In some example embodiments, the first apparatus 110 may expect to collect cell level UE trajectory information only, and thus the configured measurement granularity corresponds to a cell level measurement collection. In this case, the measurement configuration and reporting may involve the first apparatus 110 and the CU 120-1. In other words, cell level measurements are exposed from the CU 120-1 to the first apparatus 110.

FIG. 6B illustrates a schematic diagram of cell level measurements exposed from gNB-CU to OAM according to some example embodiments of the present disclosure. In the scenario 610, the first apparatus 110 may directly configure the CU 120-1 with a cell level measurement collection configuration.

The cell level measurement collection configuration may trigger cell mobility event at the CU 120-1. The CU 120-1 may select at least one terminal device for measurement collection. The CU 120-2 may start collecting the cell level measurements for example, the visited cells and the time of stay for a terminal device in each of its cells, when the selected terminal device is handed over from one cell to another cell. The collected measurements may then be exposed to the first apparatus 110.

Table 4 shows an example of cell level measurement collection in terms of time of stay of UE in each cell, which considers two cells C1 and C2. It should be understood that the example in table 4 is given for illustrative purpose, and other measurements, forms and time units are also suitable for implementation of the example embodiments.

TABLE 4
Cell level measurement collection

| Cell ID | C1 | C2 |
|---|---|---|
| Time of stay | X seconds | Y seconds |

In some example embodiments, the first apparatus 110 may expect to collect both cell level and beam level UE trajectory information, and thus the configured measurement granularity corresponds to the beam level measurement collection and the cell level measurement collection. In this case, the measurement configuration and reporting may involve the first apparatus 110, the CU 120-1 and the DU 120-2, and the cell level measurements and beam level measurements are exposed from the CU 120-1 to the first apparatus 110.

FIG. 6C illustrates a schematic diagram of beam level and cell level measurements exposed from gNB-CU to OAM according to some example embodiments of the present disclosure. In the scenario 620, the first apparatus 110 may configure the CU 120-1 with the cell level measurement collection configuration and the beam level measurement collection configuration. The CU 120-1 may select at least one terminal device for measurement collection. The CU 120-2 may start collecting the cell level measurements, for example, the visited cells and the time of stay, when the selected terminal device is handed over from one cell to another cell.

Additionally, the CU 120-1 may configure the DU 120-2 with the beam level measurement configuration, which trigger beam mobility event monitoring at the DU 120-2. When beam mobility monitoring is enabled in gNB-DU, gNB-DU starts monitoring UE's change of beam. When the UE camps on a beam, gNB-DU records the time stamp at which the UE camped on. When the gNB-DU commands the UE to move to another beam, gNB-DU calculates the time of stay. Time of stay is calculated as the difference of time units between the time stamp at which the UE moved to new beam and the time stamp at which the UE camped on the old beam. This is repeated for each beam mobility event of a UE. Thus, gNB-DU can derive a list of {beam id, time of stay} pair for any UE for which the beam mobility monitoring is triggered. One example of beam mobility is triggered by the movement of UE. Each UE is configured with beam measurement configuration based on which the UE reports one or more measured beams. gNB-DU selects the best beam and commands the UE to move to the selected beam. Another example is the Beam change which is triggered by radio conditions triggering the beam failure on a current beam. Another example is the beam level energy saving action due to which the UE has to camp on any of the other available beams.

The DU 120-2 may start collecting the beam level measurements, which are transmitted to the CU 120-1. The CU 120-1 may consolidate the cell level measurements and beam level measurements into the measurement report. The CU 120-1 may transmit the measurement report to the first apparatus 110, when the terminal device moves from RRC_CONENCTED mode to RRC_IDLE or RRC_INACTIVE mode. For example, the consolidated measurements may comprise a list of terminal devices for MDT measurement collection, a list of beams visited by the terminal devices, a set of cells visited by the terminal devices, a time of stay for a terminal device in each of the cells, and a time of stay associated with each of the list of beams.

Table 5 shows an example of cell level and beam level measurement collection in terms of time of stay of UE in beam of each of the given cells, which considers two cells C1 and C2, cell 1 has four beams B1 to B4, and cell 2 has two beams B1 and B2. It should be understood that the example in Table 5 is given for illustrative purpose, and other measurements and forms are also suitable for implementation of the example embodiments.

TABLE 5
Cell level and beam level measurement collection

| UE | Visited Cell | Time of stay | List of beams and time of stay |
|---|---|---|---|
| UE1 | Cell 1 | X seconds | B1: n1 seconds |
| | | | B2: n2 seconds |
| | | | B3: n3 seconds |
| | | | B4: n4 seconds |
| UE1 | Cell 2 | Y seconds | B1: m1 seconds |
| | | | B2: m2 seconds |

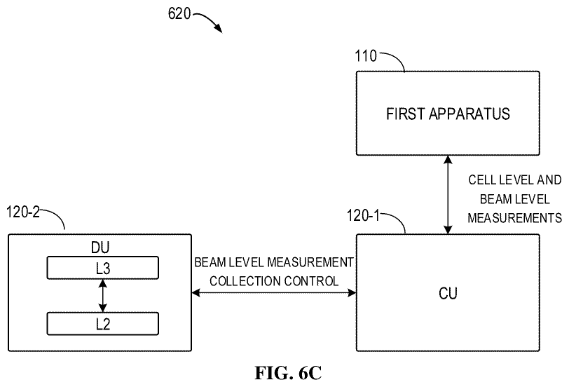

Details of a measurement configuration and reporting process of cell level measurements and beam level measurements will be described in connection with FIG. 7. The measurement configuration and reporting process 700 involves the first apparatus 110, the CU 120-1 and the DU 120-2. For the purpose of discussion, reference is made to FIG. 1 to describe the process 700.

In the process 700, the ML model training for UE trajectory is performed at the first apparatus 110. The first apparatus 110 may trigger an MDT measurement activation for UE trajectory. In some cases, the operator may configure the UE Trajectory Prediction ML Model scope (e.g., cell beam or beam level trajectory) and also a set of NG-RAN nodes and cells which are candidates for data collection. Accordingly, the first apparatus 110 may trigger the UE trajectory measurement collection at these NG-RAN nodes.

To this end, the first apparatus 110 prepares (705) a measurement collection configuration comprising a list for MDT measurement collection and a measurement granularity. The list may comprise at least one second apparatus and a plurality of cells. The measurement granularity may indicate the granularity of measurement collection, e.g., cell level and/or beam level.

In the example of FIG. 7, the measurement granularity is a combination of cell level and beam level, and thus the involved NG-RAN is the CU 120-1 and DU 120-2. In this case, the measurement collection configuration may comprise both cell level measurement collection configuration and beam level measurement collection configuration.

The first apparatus 110 transmits (710) the measurement collection configuration to the CU 120-1, which may trigger cell mobility-based measurement collection at CU 120-1. In some example embodiments, this may be performed for each terminal device camping on applicable nodes or cells when the terminal device trajectory measurements are collected from all the terminal devices. Alternatively, the first apparatus 110 may select (715) specific terminal devices for measurement collection. For example, a NG-RAN node may collect the terminal device trajectory MDT measurements if it encounters a Mobility Robustness Optimization (MRO) event, such as too early or too late handover or ping-pong. OAM can monitor the cell level RLF or MRO PM Counters. When the failure counters increase beyond a specific threshold, OAM can select those cells to trigger the UE trajectory data collection.

Alternatively, an event may be associated with threshold conditions and the NR-RAN may collect terminal device trajectory MDT measurements if the encountered number of MRO events exceeds a certain threshold. The threshold may be configured by the OAM. The threshold alternatively may be node dependent. In some examples, the threshold may be given to the NG-RAN node together with the MDT Configuration in the Trace Activation.

The CU 120-1 then starts cell mobility (e.g., L3 handover event) for the terminal devices, and collects (720) cell mobility-based measurements based on the measurement collection configuration. For example, the cell mobility-based measurements may be as shown in Table 4.

Additionally, the CU 120-1 may trigger beam mobility-based measurement collection at DU 120-2. To this end, the CU 120-1 transmits (725) the measurement collection configuration to the DU 120-2 via F1 application protocol (F1AP). In some example embodiments, the CU 120-1 may only provide the beam level measurement collection configuration to the DU 120-2. By way of example, the measurement collection configuration may be carried in a request for activating UE trajectory measurement that indicates a beam level, a list of cells, and a list of beams per cell.

In some example embodiments, the DU 120-2 may transmit (730) a response for activating UE trajectory measurement as an acknowledgement that indicates whether to accept the request. In case that the request is accepted, the DU 120-2 activates the beam mobility monitoring and collects (735) beam mobility-based measurements based on the measurement collection configuration. For example, the beam mobility-based measurements may be as shown in Table 3.

The DU 120-2 transmits (740) a terminal device trajectory measurement report comprising the collected beam mobility-based measurements to the CU 120-1 via F1AP. For example, the collected beam mobility-based measurements may be carried in a terminal device trajectory measurement report.

In some example embodiments, the measurement reporting, either at CU 120-1 or at DU 120-2, may be the MDT trace record based on NG-RAN measurements.

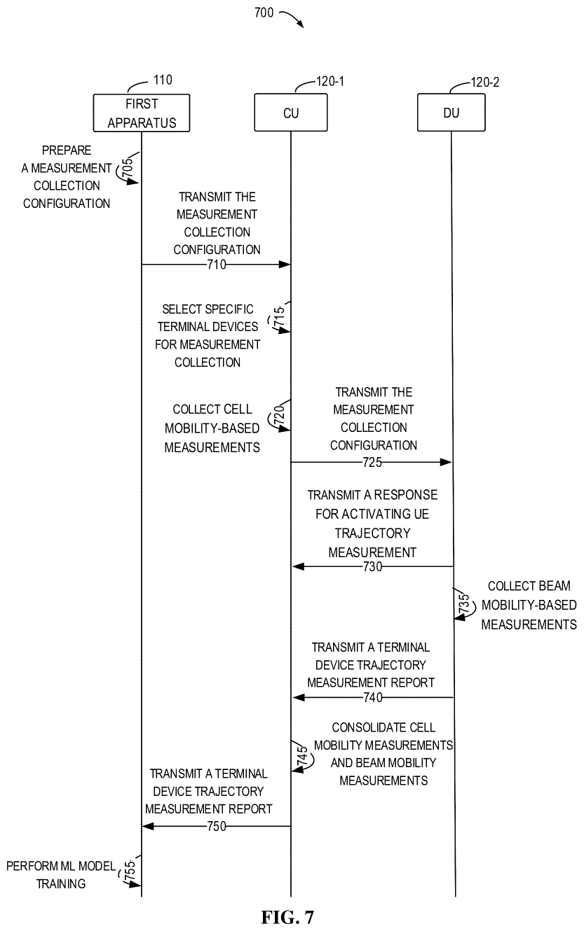

Alternatively, in some other example embodiments, the measurement reporting may be based on PM counter measurements. In these embodiments, the measurements may be modelled as “Distribution of terminal device Trajectory in Cell”. A set of bins may be defined with a specific range of values of time of stay. RAN nodes may calculate terminal device trajectory (e.g., a list of visited cells, or a list of visited beams, and time of stay) in a measurement period. For each measurement sample, the bin corresponding to the total time of stay experienced by the terminal device is incremented by one. FIG. 8 illustrates a schematic diagram of distribution 800 of terminal device trajectory in a cell according to some example embodiments of the present disclosure. N1, N2, N3, N4 indicate the number of terminal devices corresponding to the time of stay in the sampling period.

Upon receipt of the beam mobility-based measurements, the CU 120-1 consolidates (745) the cell mobility measurements and the beam mobility measurements. In particular, the CU 120-1 may create a detailed view of the time of stay in each cell using the time of stay in each beam. Table 6 shows an example of the consolidated measurements, which comprise the beam level measurements shown in Table 3 and the cell level measurements shown in Table 4. It should be understood that the example in table 6 is given for illustrative purpose, and other measurements, forms and time units are also suitable for implementation of the example embodiments.

TABLE 6
Consolidated measurements

| | Cell ID | | | |
|---|---|---|---|---|
| | C1 | | C2 | |
| | Time of stay in cell | | | |
| | X mins | | Y mins | |
| Time of stay | X1 seconds | X2 seconds | Y1 seconds | Y2 seconds |
| in beam | | | | |

The CU 120-1 transmits (750) a terminal device trajectory measurement report comprising the consolidated measurements to the first apparatus 110. As a result, the first apparatus 110 may then perform (755) ML model training by using the consolidated measurements as input data samples.

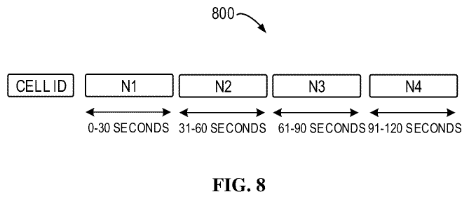

FIG. 9 illustrates a flowchart of an example method 900 implemented at an apparatus in accordance with some example embodiments of the present disclosure. The apparatus may be a network node for implementing OAM. For the purpose of discussion, the method 900 will be described from the perspective of the first apparatus 110 in FIG. 1.

At block 910, the first apparatus prepares a measurement collection configuration comprising a list for MDT measurement collection and a measurement granularity. The list comprises at least one second apparatus and a plurality of cells.

At block 920, the first apparatus transmits, to the at least one second apparatus, the measurement collection configuration for triggering an MDT measurement activation for terminal device trajectory.

At block 930, the first apparatus receives, from the at least one second apparatus, at least one MDT measurement report comprising terminal device trajectory measurements collected based on the measurement collection configuration.

In some example embodiments, the plurality of cells comprises a set of cells for the MDT measurement collection.

In some example embodiments, the measurement granularity corresponds to a beam level measurement collection, the terminal device trajectory measurements comprise a list of beams visited by a terminal device, and the at least one measurement report comprises the list of beams each associated with a time of stay.

In some example embodiments, the measurement granularity corresponds to a cell level measurement collection, the terminal device trajectory measurements comprise a set of cells visited by a terminal device, and the at least one measurement report comprises a time of stay for the terminal device in each of the set of cells.

In some example embodiments, the measurement granularity corresponds to a combination of a beam level measurement collection and a cell level measurement collection, and the terminal device trajectory measurements comprise a list of beams and a set of cells visited by a terminal device, and the at least one measurement report comprises a time of stay for the terminal device in each of the set of cells, and the list of beams each associated with a time of stay.

In some example embodiments, the method 900 further comprises: applying ML model training on at least one ML model by using the terminal device trajectory measurement collected at the measurement granularity.

In some example embodiments, the method 900 further comprises: performing at least one of the following based on the terminal device trajectory measurements: trouble shooting, performance analysis at a cell level or at a node level, or ML training or retraining by using the terminal device trajectory measurements as input data samples.

In some example embodiments, the first apparatus may comprise a network device for implementing OAM, and the at least one second apparatus comprises one of a centralized unit or a distributed unit in radio access network.

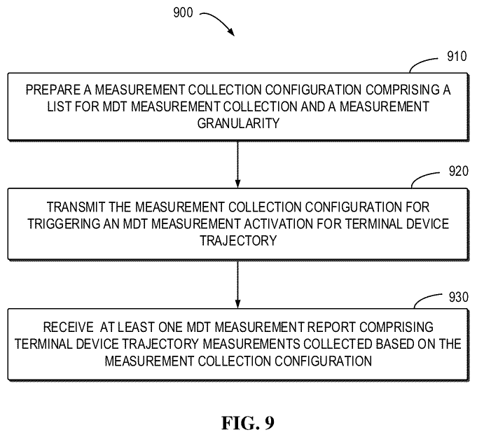

FIG. 10 illustrates a flowchart of an example method 1000 implemented at an apparatus in accordance with some example embodiments of the present disclosure. The apparatus may be a network device or node in NG-RAN, e.g., gNB-CU, gNB-DU, and so on. For the purpose of discussion, the method 1000 will be described from the perspective of the second apparatus 120 in FIG. 1.

At block 1010, the second apparatus receives, from a first apparatus, a measurement collection configuration comprising a list for MDT measurement collection and a measurement granularity. The list comprises at least the second apparatus and a plurality of cells.

At block 1020, the second apparatus 120 collects, based on the measurement collection configuration, terminal device trajectory measurements from at least one terminal device in at least a part of the plurality of cells.

At block 1030, the second apparatus transmits, to the first apparatus, an MDT measurement report comprising the terminal device trajectory measurements.

In some example embodiments, the plurality of cells comprises a set of cells for the MDT measurement collection.

In some example embodiments, the second apparatus comprises a centralized unit in radio access network, the measurement granularity corresponds to a beam level measurement collection, the terminal device trajectory measurements comprise a list of beams visited by the at least one terminal device, and the at least one measurement report comprises the list of beams each associated with a time of stay.

In some example embodiments, the second apparatus comprises a centralized unit in radio access network, and the measurement granularity corresponds to a cell level measurement collection, the terminal device trajectory measurements comprise a set of cells visited by the at least one terminal device, and the at least one measurement report comprises a time of stay for of the at least one terminal device in each of the set of cells.

In some example embodiments, the measurement granularity corresponds to a combination of a beam level measurement collection and a cell level measurement collection, the second apparatus comprises a centralized unit in radio access network that collects the terminal device trajectory measurements at the cell level.

In some example embodiments, the method 1000 may further comprise: transmitting, to at least one distributed unit in the radio access network, the measurement collection configuration for triggering an MDT measurement activation for terminal device trajectory at the beam level; receiving, from the at least one distributed unit in the radio access network, terminal device trajectory measurements collected at the beam level; and generating the measurement report by consolidating the terminal device trajectory measurements at the cell level and the terminal device trajectory measurements at the beam level.

In some example embodiments, the first apparatus comprises a network device for implementing Operation Administration and Maintenance, OAM, and the at least one second apparatus comprises one of a centralized unit or a distributed unit in radio access network.

### Example Apparatus, Device and Medium

In some example embodiments, a first apparatus capable of performing any of the method 900 (for example, the first apparatus 110 in FIG. 1) may comprise means for performing the respective operations of the method 900. The means may be implemented in any suitable form. For example, the means may be implemented in a circuitry or software module. The first apparatus may be implemented as or included in the first apparatus 110 in FIG. 1.

In some example embodiments, the first apparatus comprises: means for preparing a measurement collection configuration comprising a list for MDT measurement collection and a measurement granularity, the list comprising at least one second apparatus and a plurality of cells; means for transmitting, to the at least one second apparatus, the measurement collection configuration for triggering an MDT measurement activation for terminal device trajectory; and means for receiving, from the at least one second apparatus, at least one MDT measurement report comprising terminal device trajectory measurements collected based on the measurement collection configuration.

In some example embodiments, the plurality of cells comprises a set of cells for the MDT measurement collection.

In some example embodiments, the measurement granularity corresponds to a beam level measurement collection, the terminal device trajectory measurements comprise a list of beams visited by a terminal device, and the at least one measurement report comprises the list of beams each associated with a time of stay.

In some example embodiments, the measurement granularity corresponds to a cell level measurement collection, the terminal device trajectory measurements comprise a set of cells visited by a terminal device, and the at least one measurement report comprises a time of stay for the terminal device in each of the set of cells.

In some example embodiments, the measurement granularity corresponds to a combination of a beam level measurement collection and a cell level measurement collection, and the terminal device trajectory measurements comprise a list of beams and a set of cells visited by a terminal device, and the at least one measurement report comprises a time of stay for the terminal device in each of the set of cells, and the list of beams each associated with a time of stay.

In some example embodiments, the first apparatus further comprises: means for applying the ML model training on at least one ML model by using the terminal device trajectory measurements collected at the measurement granularity.

In some example embodiments, the first apparatus further comprises: means for performing at least one of the following based on the terminal device trajectory measurements: trouble shooting, performance analysis at a cell level or at a node level, or ML training or retraining by using the terminal device trajectory measurements as input data samples

In some example embodiments, the first apparatus comprises a network device for implementing Operation Administration and Maintenance, OAM, and the at least one second apparatus comprises one of a centralized unit or a distributed unit in radio access network.

In some example embodiments, the first apparatus further comprises means for performing other operations in some example embodiments of the method 900 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 1000 (for example, the second apparatus 120 in FIG. 1) may comprise means for performing the respective operations of the method 1000. The means may be implemented in any suitable form. For example, the means may be implemented in a circuitry or software module. The second apparatus may be implemented as or included in the second apparatus 120 in FIG. 1.

In some example embodiments, the second apparatus comprises: means for receiving, from a first apparatus, a measurement collection configuration comprising a list for MDT measurement collection and a measurement granularity, the list comprising at least the second apparatus and a plurality of cells; means for collecting, based on the measurement collection configuration, terminal device trajectory measurements from at least one terminal device in at least a part of the plurality of cells; and means for transmitting, to the first apparatus, an MDT measurement report comprising the terminal device trajectory measurements.

In some example embodiments, the plurality of cells comprises a set of cells for the MDT measurement collection.

In some example embodiments, the second apparatus comprises a centralized unit in radio access network, the measurement granularity corresponds to a beam level measurement collection, the terminal device trajectory measurements comprise a list of beams visited by the at least one terminal device, and the at least one measurement report comprises the list of beams each associated with a time of stay.

In some example embodiments, the second apparatus comprises a centralized unit in radio access network, and the measurement granularity corresponds to a cell level measurement collection, the terminal device trajectory measurements comprise a set of cells visited by the at least one terminal device, and the at least one measurement report comprises a time of stay for of the at least one terminal device in each of the set of cells.

In some example embodiments, the measurement granularity corresponds to a combination of a beam level measurement collection and a cell level measurement collection, the second apparatus comprises a centralized unit in radio access network that collects the terminal device trajectory measurements at the cell level.

In some example embodiments, the second apparatus further comprises: means for transmitting, to at least one distributed unit in the radio access network, the measurement collection configuration for triggering an MDT measurement activation for terminal device trajectory at the beam level; means for receiving, from the at least one distributed unit in the radio access network, terminal device trajectory measurements collected at the beam level; and means for generating the measurement report by consolidating the terminal device trajectory measurements at the cell level and the terminal device trajectory measurements at the beam level.

In some example embodiments, the first apparatus comprises a network device for implementing Operation Administration and Maintenance, OAM, and the at least one second apparatus comprises one of a centralized unit or a distributed unit in radio access network.

In some example embodiments, the second apparatus further comprises means for performing other operations in some example embodiments of the method 1000 or the second apparatus 120. In some example embodiments, the means comprises at least one processor; and at least one memory storing instructions that, when executed by the at least one processor, cause the performance of the second apparatus.

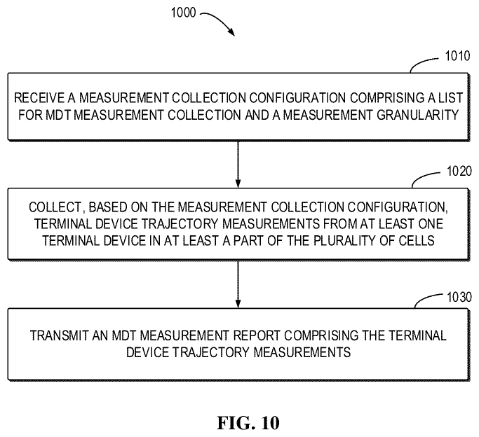

FIG. 11 is a simplified block diagram of a device 1100 that is suitable for implementing example embodiments of the present disclosure. The device 1100 may be provided to implement a communication device, for example, the first apparatus 110, or the second apparatus 120 as shown in FIG. 1. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has one or more communication interfaces to facilitate communication with one or more other modules or devices. The communication interfaces may represent any interface that is necessary for communication with other network elements. In some example embodiments, the communication module 1140 may include at least one antenna.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The instructions of the program 1130 may include instructions for performing operations/acts of some example embodiments of the present disclosure. The program 1130 may be stored in the memory, e.g., the ROM 1124. The processor 1110 may perform any suitable actions and processing by loading the program 1130 into the RAM 1122.

The example embodiments of the present disclosure may be implemented by means of the program 1130 so that the device 1100 may perform any process of the disclosure as discussed with reference to FIG. 2 to FIG. 10. The example embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

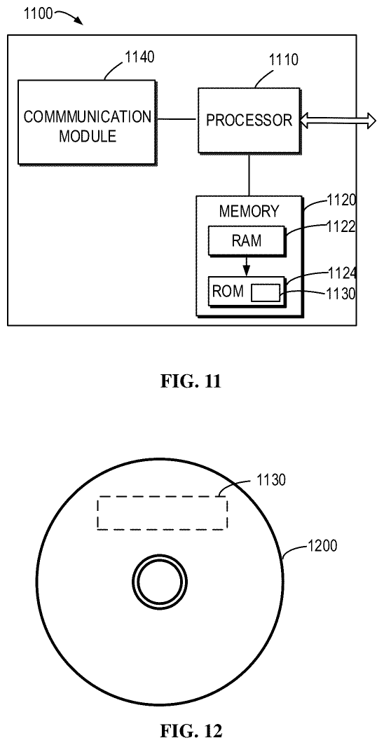

FIG. 12 shows an example of the computer readable medium 1100 which may be in form of CD, DVD or other optical storage disk. The computer readable medium 1100 has the program 1130 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
prepare a measurement collection configuration comprising a list for Minimization of Drive Test (MDT) measurement collection and a measurement granularity, the list comprising at least one second apparatus and a plurality of cells;
transmit, to the at least one second apparatus, the measurement collection configuration for triggering an MDT measurement activation for terminal device trajectory; and
receive, from the at least one second apparatus, at least one MDT measurement report comprising terminal device trajectory measurements collected based on the measurement collection configuration.

2. The first apparatus of claim 1, wherein the plurality of cells comprises a set of cells for the MDT measurement collection.

3. The first apparatus of claim 1, wherein the measurement granularity corresponds to a beam level measurement collection, the terminal device trajectory measurements comprise a list of beams visited by a terminal device, and the at least one measurement report comprises the list of beams each associated with a time of stay.

4. The first apparatus of claim 1, wherein the measurement granularity corresponds to a cell level measurement collection, the terminal device trajectory measurements comprise a set of cells visited by a terminal device, and the at least one measurement report comprises a time of stay for the terminal device in each of the set of cells.

5. The first apparatus of claim 1, wherein the measurement granularity corresponds to a combination of a beam level measurement collection and a cell level measurement collection, and the terminal device trajectory measurements comprise a list of beams and a set of cells visited by a terminal device, and the at least one measurement report comprises a time of stay for the terminal device in each of the set of cells, and the list of beams each associated with a time of stay.

6. The first apparatus of claim 1, wherein the first apparatus is further caused to:
applying machine learning (ML) model training on at least one ML model by using the terminal device trajectory measurements collected at the measurement granularity.

7. The first apparatus of claim 1, wherein the first apparatus is further caused to:
perform at least one of the following based on the terminal device trajectory measurements:
trouble shooting,
performance analysis at a cell level or at a node level, or
ML training or retraining by using the terminal device trajectory measurements as input data samples.

8. The first apparatus of claim 1, wherein the first apparatus comprises a network device for implementing Operation Administration and Maintenance (OAM) and the at least one second apparatus comprises one of a centralized unit or a distributed unit in radio access network.

9. A second apparatus comprising:
at least one processor; and
at least one memory storing instructions that, when executed by the at least one processor, cause the second apparatus at least to:
receive, from a first apparatus, a measurement collection configuration comprising a list for Minimization of Drive Test (MDT) measurement collection and a measurement granularity, the list comprising at least the second apparatus and a plurality of cells;
collect, based on the measurement collection configuration, terminal device trajectory measurements from at least one terminal device in at least a part of the plurality of cells; and
transmit, to the first apparatus, an MDT measurement report comprising the terminal device trajectory measurements.

10. The second apparatus of claim 9, wherein the plurality of cells comprises a set of cells for the MDT measurement collection.

11. The second apparatus of claim 9, wherein the second apparatus comprises a centralized unit in radio access network, the measurement granularity corresponds to a beam level measurement collection, the terminal device trajectory measurements comprise a list of beams visited by the at least one terminal device, and the at least one measurement report comprises the list of beams each associated with a time of stay.

12. The second apparatus of claim 9, wherein the second apparatus comprises a centralized unit in radio access network, and the measurement granularity corresponds to a cell level measurement collection, the terminal device trajectory measurements comprise a set of cells visited by the at least one terminal device, and the at least one measurement report comprises a time of stay for of the at least one terminal device in each of the set of cells.

13. The second apparatus of claim 9, wherein the measurement granularity corresponds to a combination of a beam level measurement collection and a cell level measurement collection, the second apparatus comprises a centralized unit in radio access network that collects the terminal device trajectory measurements at the cell level.

14. The second apparatus of claim 13, wherein the second apparatus is further caused to:
transmit, to at least one distributed unit in the radio access network, the measurement collection configuration for triggering an MDT measurement activation for terminal device trajectory at the beam level;
receive, from the at least one distributed unit, terminal device trajectory measurements collected at the beam level; and
generate the MDT measurement report by consolidating the terminal device trajectory measurements at the cell level and the terminal device trajectory measurements at the beam level.

15. The second apparatus of claim 9, wherein the first apparatus comprises a network device for implementing Operation Administration and Maintenance (OAM) and the at least one second apparatus comprises one of a centralized unit or a distributed unit in radio access network.

16. A method comprising:
receiving, at a second apparatus and from a first apparatus, a measurement collection configuration comprising a list for Minimization of Drive Test (MDT) measurement collection and a measurement granularity, the list comprising at least the second apparatus and a plurality of cells;
collecting, based on the measurement collection configuration, terminal device trajectory measurements from at least one terminal device in at least a part of the plurality of cells; and
transmitting, to the first apparatus, an MDT measurement report comprising the terminal device trajectory measurements.

17. The method of claim 16, wherein the plurality of cells comprises a set of cells for the MDT measurement collection.

18. The method of claim 17,
wherein the second apparatus comprises a centralized unit in radio access network, the measurement granularity corresponds to a beam level measurement collection, the terminal device trajectory measurements comprise a list of beams visited by the at least one terminal device, and the at least one measurement report comprises the list of beams each associated with a time of stay; or
wherein the second apparatus comprises a centralized unit in radio access network, and the measurement granularity corresponds to a cell level measurement collection, the terminal device trajectory measurements comprise a set of cells visited by the at least one terminal device, and the at least one measurement report comprises a time of stay for of the at least one terminal device in each of the set of cells.

19. The method of claim 16, wherein the measurement granularity corresponds to a combination of a beam level measurement collection and a cell level measurement collection, the second apparatus comprises a centralized unit in radio access network that collects the terminal device trajectory measurements at the cell level.

20. The method of claim 19, further comprising:
transmitting, to at least one distributed unit in the radio access network, the measurement collection configuration for triggering an MDT measurement activation for terminal device trajectory at the beam level;
receiving, from the at least one distributed unit, terminal device trajectory measurements collected at the beam level; and
generating the MDT measurement report by consolidating the terminal device trajectory measurements at the cell level and the terminal device trajectory measurements at the beam level.
